(19) United States
(12) Patent Application Publication
(10) Pub. No.: US 2008/0187797 A1
(43) Pub. Date: Aug. 7, 2008

(54) Fuel processor for fuel cell systems

(75) Inventor: David Edlund, Hopkinton, MA (US)

Correspondence Address: EDWARDS ANGELL PALMER & DODGE LLP, P.O. BOX 55874, BOSTON, MA, 02205, US

(73) Assignee: Protonex Technology Corporation, Southborough, MA (US)

(21) Appl. No.: 12/006,893

(22) Filed: Jan. 7, 2008

Related U.S. Application Data
(63) Continuation-in-part of application No. 11/484,514, filed on Jul. 10, 2006.

(51) Int. Cl. H01M 8/06; B01D 1/02; B23P 15/26; F28F 9/02

(52) U.S. Cl. 429/17; 422/188; 422/198; 29/890.03

(57) ABSTRACT

A fuel processor assembly for producing a hydrogen rich stream for a fuel cell includes a reformer, a vaporizer adjacent the reformer, a heat transfer block around at least a portion of the reformer and the vaporizer and a heating element coupled to the heat transfer block for providing heat to the block during start up. To cold start the fuel processor, the heating element is activated to heat the heat transfer block. When a temperature of the heat transfer block reaches operational for the reformer, the heating element is turned off and an alternative source of heat is utilized for the endothermic reaction.

### CROSS-REFERENCE TO RELATED APPLICATION

This application claims priority to and is a continuation-in-part of U.S. patent application Ser. No. 11/484,514, filed Jul. 6, 2007, which is incorporated herein by reference.

### BACKGROUND OF THE INVENTION

Fuel cells are electrochemical devices that produce direct current (DC) electricity by the reaction of a fuel with an oxidant, typically producing byproducts of heat and water. Common fuels are hydrogen, methanol, and carbon monoxide; however, carbon monoxide can only be used as a fuel in high-temperature fuel cells operating at temperatures >400° C. The most common oxidant is oxygen, either in a relatively pure form or from air. Fuel cells contain an anode, a cathode, and an electrolyte barrier between the anode and cathode. The fuel is introduced at the anode and the oxidant is introduced at the cathode. The electrolyte barrier, commonly referred to as a membrane-electrode assembly or MEA, is an ionically conductive thin barrier that is relatively impermeable to the fuel and oxidant, and is electrically insulating. Known fuel cell designs and operating principles are described in, for example, The Fuel Cell Handbook, 7th Edition (2004) published by the US Department of Energy, EG&G Technical Services under contract DE-AM26-99FT40575.

Many configurations of fuel cell systems are known. Portable fuel cell systems are based on several different types of fuel cells, including proton-exchange membrane fuel cells (PEMFC) that operate at temperatures less than 85° C. and that use high-purity hydrogen as the fuel; PEMFCs that operate at temperatures in the 135° C. to 200° C. range and that use hydrogen-rich reformate as the fuel; direct methanol fuel cells (DMFC) that operate at temperatures less than 85° C. and that use methanol as the fuel; and solid oxide fuel cells (SOFC) that operate at temperatures in the range of 500° C. to 900° C. and that use hydrogen-rich reformate as the fuel. Fuel processors prepare the fuel supply for use by the fuel cell. Often the fuel processor has many components including a vaporizer or reformer. Conventional reformers are a bundle of tubes having large diameters in the range of 25-150 mm. Each tube is a packed with granules or bulk material to form a catalytic bed. Such tubes are relatively inexpensive and the technology has been utilized to meet large scale requirements. Mechanical events such as vibrations and shocks can break down the bed. Often, channels form that undesirably create flowpaths that allow the fuel stream to pass without significant reaction.

The fuel preparation process is also endothermic so that heaters are used to externally apply heat to the tubes to increase process efficiency. Due to the large size and wall thickness of the tubes, the reaction to the heating process is relatively slow (i.e., an undesirable gradient occurs). Further, the bed can break down during this thermal cycling.

Velocys, Inc. of Plain City, Ohio has developed an alternative microchannel reactor in an effort to overcome the slow heat gradient. For example, see U.S. Pat. Nos. 7,250,151; 7,029,647; 7,014,835; and 6,989,134, each of which is incorporated herein by reference. Velocys, Inc. forms microchannels of 0.1-1.0 mm in a thin metal plate. Because the microchannels are so small, a bulk material cannot be used as a catalyst. Rather, a wash coat of a catalyst material is applied. Hence, the heat applied to the plate is very quickly transferred to the reaction zone. To scale up the microchannel technology, a plurality of plates are stacked. Unfortunately, the microchannel technology is expensive to manufacture and heavy as a large amount of a metal such as steel is necessary.

There is therefore a need for a fuel processor for a fuel cell system that is affordable, has a small temperature gradient and is robust under mechanical duress and thermal cycling. The present invention addresses these needs among others.

### SUMMARY OF THE INVENTION

The subject technology relates to a portable and other fuel cell systems incorporating a fuel reformer that converts a liquid or gaseous fuel to a hydrogen-rich reformate stream. The fuel reformer has a small temperature gradient and a light, robust design suitable for wide application in the art of fuel cells.

In one embodiment, a fuel processor assembly for producing a hydrogen rich stream for a fuel cell includes a reformer, a vaporizer adjacent the reformer, a heat transfer block around at least a portion of the reformer and the vaporizer and a heating element coupled to the heat transfer block for providing heat to the block during start up. To cold start the fuel processor, the heating element is activated to heat the heat transfer block. When a temperature of the heat transfer block reaches operational for the reformer, the heating element is turned off and an alternative source of heat is utilized for the endothermic reaction.

In another embodiment, the subject technology is directed to a method for cold starting a fuel processor for a fuel cell including the steps of activating a block heater to elevate a temperature of a heat transfer block, wherein a vaporizer and reformer are located at least partially within the heat transfer block and monitoring the temperature of the heat transfer block so that the block heater is turned off near a minimum operating temperature of the reformer. The method may further include the steps of activating a pump to urge fuel through the vaporizer and reformer to generate a hydrogen output stream and using a burner to continually heat the heat transfer block, wherein a fuel supply for the burner is a portion of the hydrogen output stream.

### BRIEF DESCRIPTION OF THE DRAWINGS

FIG. 1 is a schematic of an exemplary fuel cell system of the invention.

FIG. 2 is a schematic of an exemplary fuel cell stack of the invention.

FIGS. 3-9 are schematics of other exemplary arrangements for heating the fuel cell stack of the invention.

FIG. 10 is a somewhat schematic view of an exemplary fuel processor of the invention.

FIG. 11A is a perspective view of an exemplary reformer tube bundle of the invention.

FIG. 11B is a cross-sectional view of the reformer tube bundle of FIG. 11A.

FIG. 12a is a perspective view of an exemplary tubular reformer of the invention with a vaporizer around the tubular reformer in accordance with the invention.

FIG. 12b is a side view of the tubular reformer of FIG. 12a.

FIG. 12c is another side view of the tubular reformer of FIG. 12a.

FIG. 12d is an end view of the tubular reformer of FIG. 12a.

FIG. 13a is a top perspective view of an exemplary vaporizer and tubular reformer of FIG. 12a-d with a heat transfer block cast around the vaporizer and tubular reformer in accordance with the invention.

FIG. 13b is a bottom end perspective view of an exemplary vaporizer and tubular reformer of FIG. 13a that illustrates block heaters.

FIG. 14a is a perspective view of another vaporizer and tubular reformer in accordance with the invention.

FIG. 14b is a top view of the tubular reformer of FIG. 14a.

FIG. 14c is a side view of the tubular reformer of FIG. 14a.

FIG. 14d is an end view of the tubular reformer of FIG. 14a.

FIG. 15 is a perspective view of an exemplary vaporizer and tubular reformer of FIG. 14a-d with a heat transfer block cast around the vaporizer and tubular reformer in accordance with the invention.

FIG. 16a is a perspective view of still another exemplary vaporizer and tubular reformer with a heat transfer block cast around the vaporizer and tubular reformer shown in phantom line in accordance with the invention.

FIG. 16b is a side view of the vaporizer and tubular reformer of FIG. 16a.

FIG. 16c is an end view of the vaporizer and tubular reformer of FIG. 16a.

FIG. 16d is an exploded perspective view of the vaporizer and tubular reformer of FIG. 16a.

FIG. 17 is a perspective view of vaporizer and tubular reformer of FIGS. 16a-d within a housing in accordance with the invention.

### DETAILED DESCRIPTION OF PREFERRED EMBODIMENTS

As used herein, the term “about” when used in reference to a numerical value means the indicated numerical value +10% of that value.

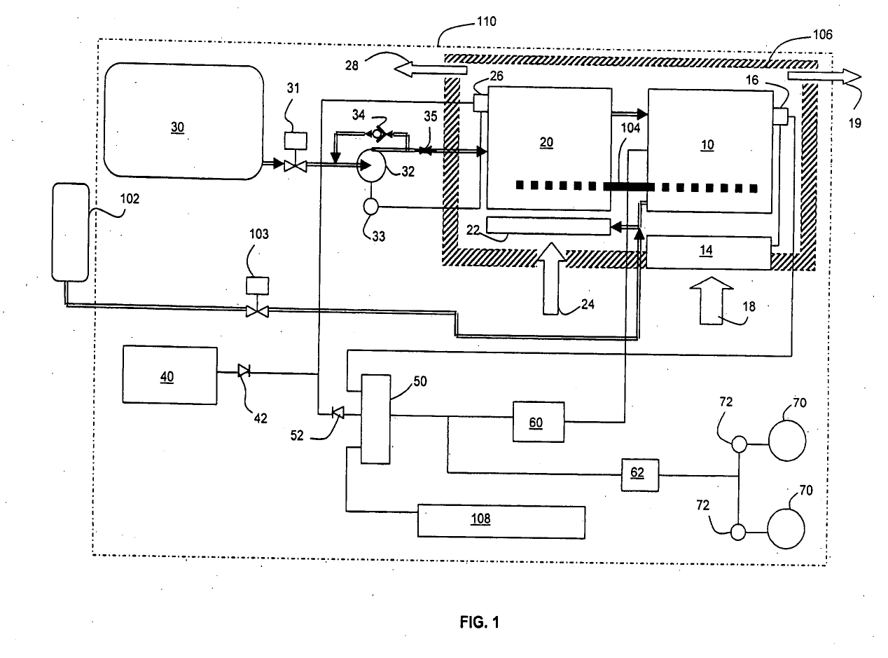

An exemplary embodiment of the invention is shown schematically in FIG. 1, the system comprising fuel cell stack 10, at least one fuel cell cooling fan 14, fuel cell thermal switch 16, fuel cell air feed 18 and fuel cell combustion exhaust duct 19. The system further comprises fuel reformer 20 operatively coupled to fuel cell stack 10, fuel reformer burner 22, fuel reformer air feed 24, fuel reformer thermal switch 26 and fuel reformer combustion exhaust duct 28. One or more heat pipes 104 pass from the vicinity of the fuel reformer burner 22 into the fuel cell stack 10. Fuel reformer 20 is fed fuel from fuel reservoir 30 via fuel reservoir shut off valve 31, fuel reservoir fuel pump 32, fuel pump switch 33, fuel check valve 34 and fuel feed orifice 35.

All of the system's components with the exception of a fuel tank 102 for supplying fuel to fuel reformer/fuel cell stack burner(s) are preferably contained within a substantially airtight, openable system case 110. Within the case, fuel cell stack 10 and fuel reformer 20 and their associated heating and cooling components are preferably substantially surrounded by insulation 106.

The system is controlled in part by a simple electrical circuit comprising battery pack 40, battery pack diode 42, fuse box 50, fuse box diode 52, DC/DC voltage converter/regulator 60, circuit breaker 62, power outlets 70 and power outlet(s) switch(es) 72. A primary function of the electrical circuit is to couple the electrical power generated by fuel cell stack 10 to power outlets 70.

Fuel reservoir 30 contains a liquid fuel, preferably a mixture of methanol and water comprising from about 50 to about 60 wt % methanol, more preferably about 55 wt %, balance water. The fuel is pumped from fuel reservoir 30 into fuel reformer 20 by fuel pump 32. To ensure that the feed flow rate of the fuel is correct and not subject to fluctuations by the discharge flow rate of pump 32, pump 32 is preferably oversized by at least 10% and by as much as 50-fold, meaning that the discharge flow rate of pump 32 may be as little as 1.1 and as much as 50 times the required flow rate of fuel into fuel reformer 20.

Flow rate of fuel into fuel reformer 20 is regulated by a bypass loop comprising feed orifice 35 and check valve 34. Feed orifice 35 is sized to allow a restricted flow of fuel that matches the desired flow rate of fuel into reformer 20. Check valve 34 serves to maintain the desired pressure at the upstream side of feed orifice 35 since flow through the orifice is dependent on a predetermined pressure differential across the orifice. Both check valve 34 and feed orifice 35 are commercially available from O'Keefe Controls Company, Monroe, Conn. For example, a fuel flow rate into the reformer 20 of 1.9 mL/min may be achieved with an orifice 0.004 inch in diameter and a pressure differential across the orifice of 2 psig; a fuel flow rate of 5.2 mL/min into the reformer may be achieved with an orifice of 0.005 inch in diameter and a pressure differential of 5 psig; and a fuel flow rate of 15 mL/min into the reformer may be achieved with an orifice of 0.011 inch in diameter and a pressure differential of 2 psig.

Check valve 34 preferably has a cracking (or opening) pressure of from 0.01 to 10 psig to allow the use of low pressure pumps. The discharge side of check valve 34 is returned to the inlet side of pump 32 to complete a bypass loop. Alternatively, the discharge side of check valve 34 may be plumbed into the fuel reservoir (not shown). Preferably, the discharge side of check valve 34 is plumbed into the feed line between the downstream side of shut-off valve 31 and the inlet to pump 32, as shown in FIG. 1.

After passing through feed orifice 35, fuel flows into reformer 20. Reformer 20 is preferably heated to a temperature of from about 130° C. to about 450° C., as detailed below. Reformer 20 is preferably in the form of a tube that contains a catalyst that is formulated to accelerate the reaction of methanol and water in the liquid fuel to a product stream comprised predominantly of hydrogen, carbon dioxide, carbon monoxide, and water. Such a catalyst is commercially available from Süd-Chemie, Inc. of Louisville, Ky. The reformer need not function at a constant temperature. Indeed, it is preferred that the reformer operate over a range of temperatures such that the inlet of the reformer is at a higher temperature than its outlet. Preferred operating temperature ranges are: inlet 200° C.-700° C. and outlet 130° C.-250° C.; more preferably inlet 250° C.-450° C. and outlet 150° C.-250° C.; even more preferably inlet 300° C.-450° C. and outlet 150° C.-250° C.; still more preferably inlet 200° C.-350° C. and outlet 130° C.-250° C.; and most preferably inlet 250° C.-350° C. and outlet 130° C.-200° C.

Reformer 20 preferably is operated at relatively low pressure (<10 psig) to reduce its mass, thereby reducing its cost. Because the reformer operates at relatively low temperatures and low pressures, it may be made of stainless steel, copper, and alloys containing copper. Although a tubular shape for the reformer is convenient and inexpensive, the reformer may be virtually any other shape, including rectangular. The reformer may be a single tube or rectangular channel, or it may be multiple tubes or rectangular channels arranged for parallel flow of the fuel feed stream.

Reformer 20 is preferably heated directly by a reformer burner 22 in close proximity to the reformer so that the hot combustion gases therefrom are directed at the reformer, preferably from 1 to 3 inches below the reformer. Fuel for reformer burner 22 preferably comprises waste anode gas from fuel cell stack 10. One embodiment of reformer burner 22 is a pipe made of stainless steel or copper, between 0.25 and 1 inch in diameter, and incorporating a series of small holes 0.01 to 0.10 inch in diameter, or slots 0.01 to 0.10 inch wide and up to 1 inch in length, arranged in a linear pattern along one side of the heat pipe. Alternatively, a single narrow slot 0.01 to 0.10 inch wide may be incorporated into reformer burner 22 instead of linear arrays of holes or slots. The waste anode gas fuel is discharged upwardly through such holes or slots and burns as it mixes with combustion air 24.

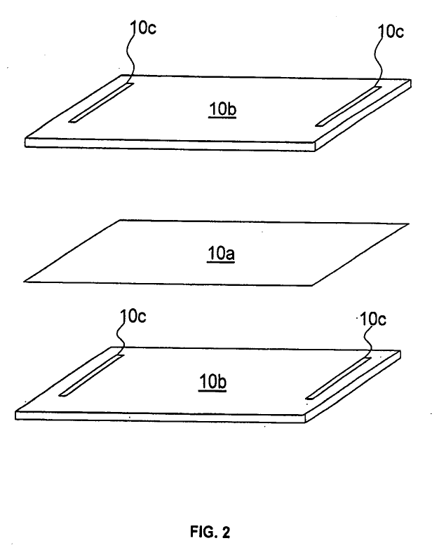

Hydrogen-rich reformate that exits fuel reformer 20 is still hot (preferably 130° C.-200° C.) as it flows directly into the anode side of fuel cell stack 10, shown in FIG. 2. Fuel cell stack 10 consists of membrane electrode assembly (MEA) 10a, comprising an anode and a cathode, the MEA being sandwiched between bipolar plates 10b, with slits 10C forming a reformate manifold through which reformate is fed to the anode side of the MEA. Inside fuel cell stack 10, hydrogen from the hydrogen-rich reformate gas stream reacts at the anode and oxygen from fuel cell air feed 18 reacts at the cathode. The result is electricity, with byproducts heat and water. Not all of the hydrogen is consumed at the fuel cell anode because an excess of hydrogen-rich reformate is supplied to the anode, thereby ensuring that there will be fuel gas for reformer burner 22.

Fuel cell stack 10 preferably operates at a temperature within the range of from about 100° C. to about 250° C., more preferably from about 140° C. to about 200° C. Suitable membrane-electrode assemblies for this range of operating temperatures are commercially available from Pemeas Fuel Cell Technologies of Frankfurt, Germany as Celtec®-P Series 1000. As noted, fuel cell stack 10 produces heat as a byproduct of the generation of electrical power. Under typical operating conditions, the total fuel cell energy output (electrical power plus heat) is on the order of 50%-60% electricity and 40%-50% heat. Thus, once the fuel cell has been heated sufficiently to produce electrical power, it is self-sustaining and even must be cooled to maintain an acceptable operating temperature.

One or more cooling fans 14 are located in proximity to fuel cell stack 10 to cool the same by blowing air over it when it is operating. Preferably cooling fan(s) 14 are located beneath the fuel cell so that cooling air is blown upward over cooling fins located within the fuel cell. To maintain adequate temperature regulation of the fuel cell the fans are switched on and off in response to a temperature-responsive control device such as a thermal switch; an exemplary commercially available thermal switch is Model 49T bimetal thermal switch from Thermo-O-Disc, Inc. of Mansfield, Ohio. The thermal switch is normally open and closes upon heating when the set-point temperature is reached. Upon cooling from a hot state in which the thermal switch is closed, the switch opens when the temperature of the switch falls below the set-point temperature. Another example of a temperature-responsive control device is a thermocouple in combination with a suitable electrical circuit that interprets the thermocouple reading as a temperature relative to a set-point temperature, activating or deactivating a relay or switch in response to the sensed temperature to turn on or turn off the cooling fan(s).

The fuel cell stack is preferably configured so that the cooling air serves two purposes: it dissipates heat from the fuel cell stack during operation and it flows over the cathode to provide oxygen to the cathode, known as an open cathode fuel cell. An advantage of orienting the fuel cell so that the cooling fan(s) are below the fuel cell and blow air vertically up through the fuel cell's cooling channels is that this orientation promotes convective air flow through the cooling channels and over the cathode even when the cooling fan(s) are not operating. Thus, even if the fuel cell is at a temperature that is below the set-point temperature at which the cooling fan(s) would turn on, air will still flow by thermal convection over the cathode, thereby providing necessary oxygen to the cathode.

Because the fuel reformer and the fuel cell stack operate at temperatures substantially above normal ambient temperatures, they are preferably enclosed in an insulated enclosure to reduce heat loss to the surrounding environment; the insulated enclosure in turn is preferably fitted within a box or case (the system case). The insulated enclosure is generally cubic or elongated cubic in shape, although it may also be more generally cylindrical in shape. The insulated enclosure has a top, a bottom, and is surrounded by sides completely around its perimeter. The insulated enclosure is preferably fitted with one or more openings in its bottom to admit air into the enclosure for the dual purpose of providing combustion air to the reformer burner and cooling air to the fuel cell stack. Combustion exhaust from the reformer burner must be exhausted from the insulated enclosure, and cooling air, after passing through the fuel cell stack, must also be exhausted from the insulated enclosure. These combined exhaust streams are preferably allowed to exhaust through one or more openings generally located at or near the top of the insulated enclosure.

The size and dimensions of the openings to admit air into the enclosure and to allow exhaust from the enclosure are preferably designed to provide for an acceptably low pressure drop but at the same time not allow excessive heat to escape the enclosure. In one embodiment, the interior dimensions of the insulated enclosure surrounding the fuel reformer and the fuel cell stack is approximately 10×10×6.5 inches high. Other dimensions may be suitable, depending on the size and shape of the fuel reformer and the fuel cell stack. The thickness of insulation on the walls of the enclosure preferably ranges from 0.25 to 2 inches, with 0.5 to 1 inch being most preferred. The thickness of insulation on the bottom of the enclosure preferably ranges from 0.1 to 1 inch, with 0.25 to 0.5 inch being most preferred. The thickness of insulation on the top preferably ranges from 0.05 to 1 inch thick, with 0.1 to 0.25 inch thick being most preferred. Exemplary dimensions for the opening below the fuel reformer are about 1-2 inches×5-7 inches. Exemplary dimensions for the opening below the fuel cell stack are about 2.5-3.5 inches×5-7 inches. Exemplary dimensions for opening(s) at or near the top of the insulated enclosure to allow for exhaust from the enclosure are 2.5-3.5 inches×5-7 inches; 1-2 inches×5-7 inches; 0.5-1 inch×7-10 inches; or combinations of one or more openings of these approximate dimensions.

As noted above, the entire fuel cell system is contained within the system case that, when closed, is more or less airtight. The system case must be opened in order to operate the fuel cell since air must flow freely into and out of both the fuel reformer and the fuel cell stack during operation. However, when the fuel cell stack is not operating, it must be protected from ambient air since the membrane-electrode assembly is hygroscopic and can be damaged by absorbing moisture from the air. In addition, the membrane of the membrane-electrode assembly may be damaged by exposure to atmospheric pollutants such as dust and hydrocarbons.

The system case is indicated schematically in FIG. 1 as the dashed line 110 surrounding all of the fuel cell system components. The fuel reservoir may be contained within the system case or be external to the system case. An exemplary airtight system case is Storm Case model iM2600 from Storm Case, Inc. of South Deerfield, Mass. The system case preferably has a hinged lid that securely closes and seals out air when the case is closed. To operate the fuel cell system, the system case lid must be opened and remain open during operation. The insulated enclosure containing the fuel reformer and the fuel cell stack is preferably elevated slightly above the bottom of the system case by, e.g., about 0.1-1 inch, more preferably 0.25-0.5 inch, so as to provide an opening for air to be drawn into the opening beneath both the fuel reformer and the fuel cell stack.

In addition to the aforementioned fuel pump and fuel cell cooling fan(s) other electromechanical, mechanical, and electrical components are required for the operation of the fuel cell system, as described below.

FIG. 1 also includes a schematic of an exemplary electrical circuit. A DC/DC voltage regulator 60 is required to convert the unregulated voltage output from fuel cell stack 10 to a commercially important, regulated voltage such as nominal 12 V DC. Typical commercial 12 V DC appliances and products are designed to operate from an automotive 12 V battery. These appliances and products are designed to operate at a voltage that falls within the nominal voltage limits for a 12 V battery which is 10.8 V to 14.4 V. The unregulated voltage output from the fuel cell is passed into the DC/DC voltage converter 60 that puts out voltage within this range of 10.8 V to 14.4 V. An example of a suitable commercially available DC/DC voltage converter/regulator is Model LVBM-12V from Sierra West Power, Inc. of Los Cruces, N. Mex.

Because DC/DC converters get hot when operated, internal cooling within the system case is beneficial. A case cooling fan 108, or multiple case cooling fans, may be incorporated into the system for cooling the DC/DC converter/regulator. The DC electrical power from the DC/DC voltage converter/regulator is preferably connected to one or more power outlets 70 via a suitable circuit protection device such as a circuit breaker 62 or a fuse. Power outlet(s) 70 may be any commercial device that the user may plug appliances into. One exemplary suitable power outlet is a cigarette-lighter style such as is commonly found in automobiles and recreational boats. Power outlet(s) may be further controlled by one or more user-activated manual switch(es) 72, whereby electrical power is delivered to the outlet(s) only when the user turns on the switch(es). A user-activated manual switch 33 may also be used to control the delivery of electrical power to fuel pump 32. The system's pump and fans are protected against current overload by appropriately sized electrical fuses contained in fuse box 50.

A battery pack 40 preferably holds a sufficient number of primary or secondary batteries to power the fuel pump during start-up. For example, the battery pack may contain eight AA batteries delivering nominal 12 V DC to power the fuel pump during start-up. Alternatively, C or D cells could also be used, either as primary cells or rechargeable cells. The electrical circuit is preferably designed so that the battery pack cannot be charged when the fuel cell is in operation so primary batteries may be safely used. This feature is achieved by incorporating a diode 42 in the electrical line from battery pack 40. However, if battery pack 40 comprises secondary batteries then a battery-charging circuit is preferably coupled to battery pack 40, in which case diode 42 would be omitted from the circuit. Also, since the battery pack is not designed to provide power to the user's appliances, a second diode 52 is placed in the fuel cell electrical line that connects to the fuel pump, thereby blocking electrical power from the battery pack from reaching the power outlet(s).

During start-up, the fuel pump is initially off, and it is designed to remain off until the fuel reformer has been heated to at least a minimum threshold temperature. For example, depending on the catalyst used in the fuel reformer, the minimum threshold temperature may be anywhere between about 125° C. and about 300° C., preferably from about 125° C. to about 250° C., more preferably from 125° C. to 200° C., still more preferably from 150° C. to 225° C., and most preferably from 130° C. to 170° C. A temperature-responsive control device is used to detect when the fuel reformer has reached the minimum threshold temperature and then turn on the pump—this is done automatically so the user does not have to monitor the temperature of the fuel reformer during start-up. As previously mentioned, an example of such a temperature-responsive control device is the Model 49T bimetal thermal switch from Thermo-O-Disc, Inc. The thermal switch is normally open and closes upon heating when the set-point temperature is reached to turn on the fuel pump. Upon cooling from a hot state in which the thermal switch is closed, the switch opens when the temperature of the switch falls below the set-point temperature. Another example of a temperature-responsive control device is a thermocouple in combination with a suitable electrical circuit that interprets the thermocouple reading as a temperature relative to a set-point temperature, activating a relay or switch in response to the sensed temperature to turn on the fuel pump.

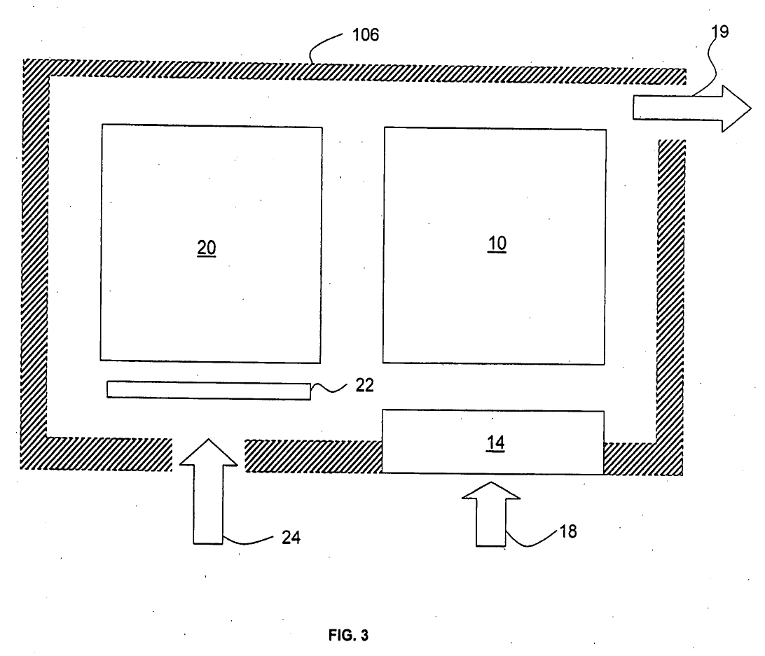

Several different embodiments of the insulated enclosure containing the fuel reformer and the fuel cell stack are shown in FIGS. 3-5. In FIG. 3, the air 24 for the reformer burner 22 is drawn in from an opening below the burner. Air 18 for cooling fuel cell 10 and for the fuel cell's cathode is drawn in from an opening below fuel cell cooling fan(s) 14. Exhaust 19 is expelled from a single opening located near the top of the insulated enclosure and in proximity to the fuel cell stack. This arrangement allows for hot combustion gases to pass over a portion of the fuel cell stack to help heat it during start-up when it is likely to be below its operating temperature. Exhaust 19 is shown in FIG. 3 exiting through the top side of the insulated enclosure, but it could also exit upward through an opening in the top of the insulated enclosure.

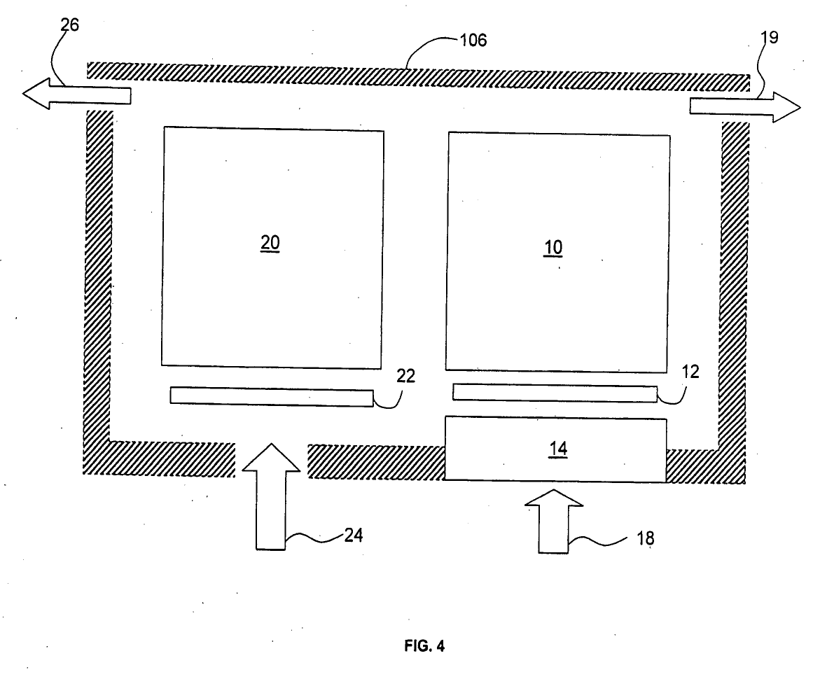

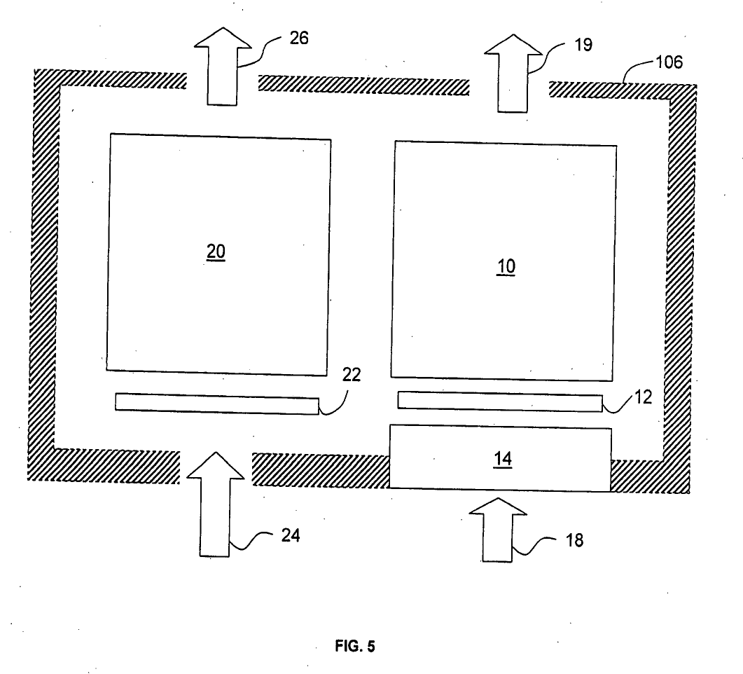

FIG. 4 shows essentially the same configuration as FIG. 3 except a burner 12 is shown below fuel cell stack 10 for heating the fuel cell during start-up when the fuel cell is at a temperature less than its desired minimum operating temperature. As mentioned above, the desired minimum operating temperature of the fuel cell stack is preferably between about 100° C. and about 140° C., more preferably about 130° C. Any convenient fuel may used to fire the burner. An especially preferred fuel that is widely available and portable is propane packaged in disposable cylinders. The exhaust is shown on FIG. 4 exiting through the top sides at two locations, although it could also exit through only one port or more than two ports, or through one or more openings in the top of the insulated enclosure, as shown in FIG. 5.

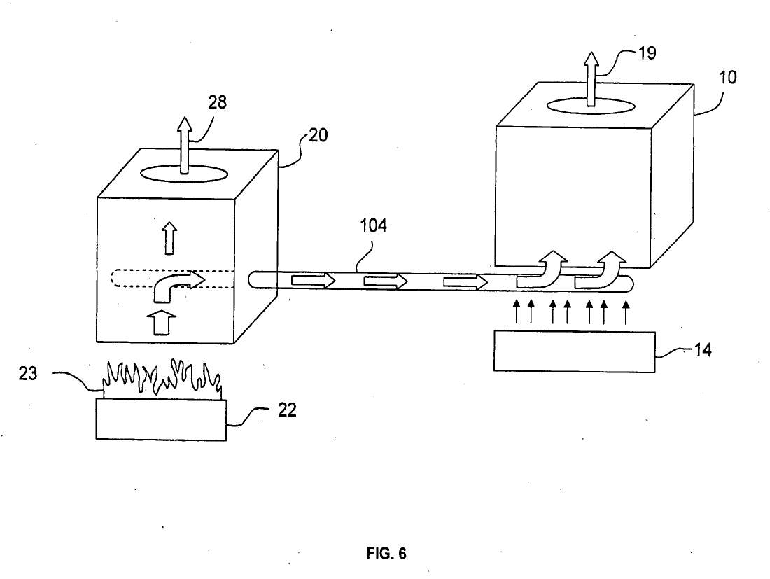

FIG. 6 shows air inlet and exhaust openings similar to those shown in FIG. 4, as well as a preferred means for heating fuel cell stack 10 during start-up. One or more heat pipes 104 extend from fuel reformer 20 to fuel cell stack 10. The basic construction of a heat pipe is an evacuated tubular pipe containing a small amount of a fluid such as water and sealed at its ends. Exemplary suitable heat pipes are made of copper and contain the small amount of water in the liquid and vapor phases in equilibrium.

Another advantage of heat pipes for heating the fuel cell stack during start-up is that they are completely passive and have no moving parts to wear out. Heat pipes are also quiet, small, lightweight, and do not require any active control. Such heat pipes are commercially available from, for example, Thermacore, Inc. of Lancaster, Pa. and Furukawa America, Inc. of Santa Clara, Calif. Such heat pipes are particularly useful for transferring heat from one location to another due to their exceedingly high thermal conductivity. One end of the heat pipe(s) is heated in or near reformer burner 20, conducting heat to its distal end to either the underside or the inside of fuel cell stack 10, as schematically shown in FIG. 5, wherein arrows indicate the direction of heat flow from a region of high temperature in the vicinity of the reformer burner flame 23 to a region of cooler temperature in the vicinity of fuel cell stack 10. Common diameters for heat pipes include 3 mm, 4 mm, 6 mm, 8 mm, 9.5 mm, and 12.7 mm. Generally speaking, the larger the diameter of the heat pipe, the more heat it will conduct. For example, Thermacore rates the typical heat conduction of its heat pipes as follows: for 3 mm, 10 W; 4 mm, 17 W; 6 mm, 40 W; 8 mm, 60 W; 9.5 mm, 80 W, and 12.7 mm, 120 W.

The number of heat pipes that are used to heat the fuel cell stack during start-up is a function of (1) the mass and heat capacity of the fuel cell stack, (2) the desired start-up time (or time to heat the fuel cell stack to its minimum operating temperature), and (3) the diameter of the heat pipe. As an example, the fuel cell stack of the inventive system may comprise 10 electrochemical cells, nine graphite bipolar plates, and two monopolar graphite end plates with a total mass of about 0.6 kg. About 61 kJ of heat will be required to heat the fuel cell stack from 15° C. to 150° C., assuming negligible heat loss. If the total desired time to heat the fuel cell stack to 150° C. is 5 minutes, the required heat input will be 61 kJ÷300 sec, or 203 W. However, if the desired time to heat the fuel cell to 150° C. is 2 minutes, then the heat input needs to be 61 kJ÷120 sec, or 508 W.

One design solution to deliver approximately 203 W to the fuel cell stack is to use five 6 mm heat pipes (5×40 W/heat pipe=200 W). Alternatively, three 9.5 mm diameter heat pipes would also deliver sufficient heat to the stack (3×80 W/heat pipe=240 W). Or, 20 3 mm heat pipes could be used (20×10 W/heat pipe=200 W).

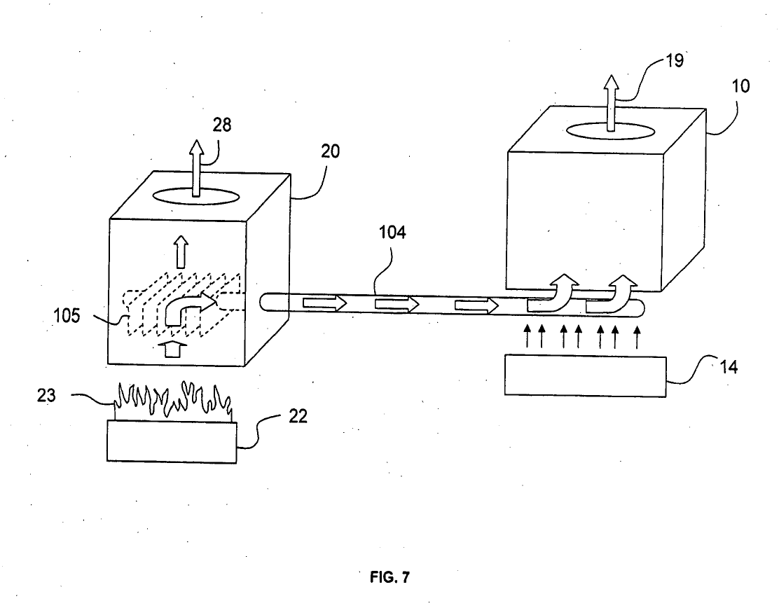

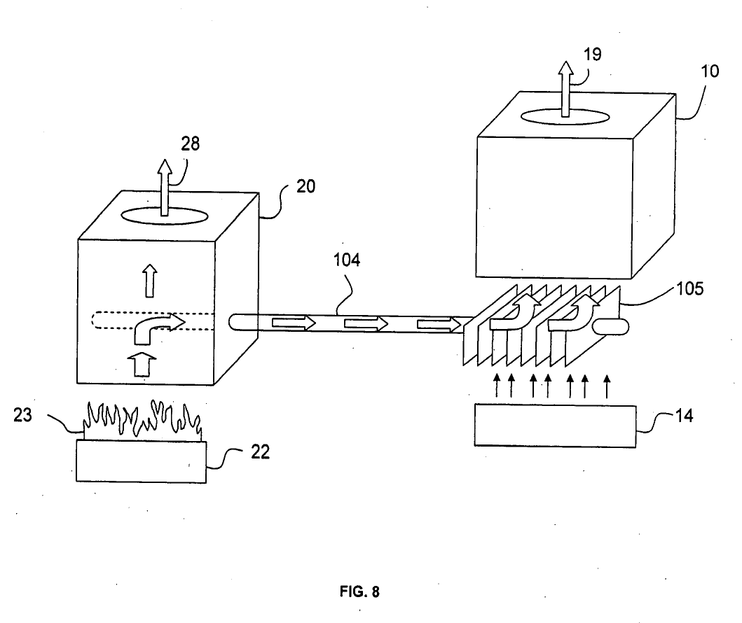

FIG. 7 shows another embodiment of the invention using one or more heat pipes 104 to heat the fuel cell stack. However in this case the heat pipe(s) are located immediately beneath and outside of fuel cell stack 10 and air is blown over the heat pipes, whereby the air is heated prior to flowing over the fuel cell stack. This embodiment may be especially advantageous when large diameter heat pipes are used since the incorporation of large diameter heat pipes inside fuel cell stack 10 may disrupt the fuel cell stack's functional design, for instance, by blocking or restricting air flow through one or more of the cathode-side air channels. Optionally, metal heat dissipation fins 105 as shown in FIG. 8 may be coupled to the heat pipe(s) at the end nearest the fuel cell stack to increase the surface area for heat dissipation into the flowing air stream passing over the heat pipe(s).

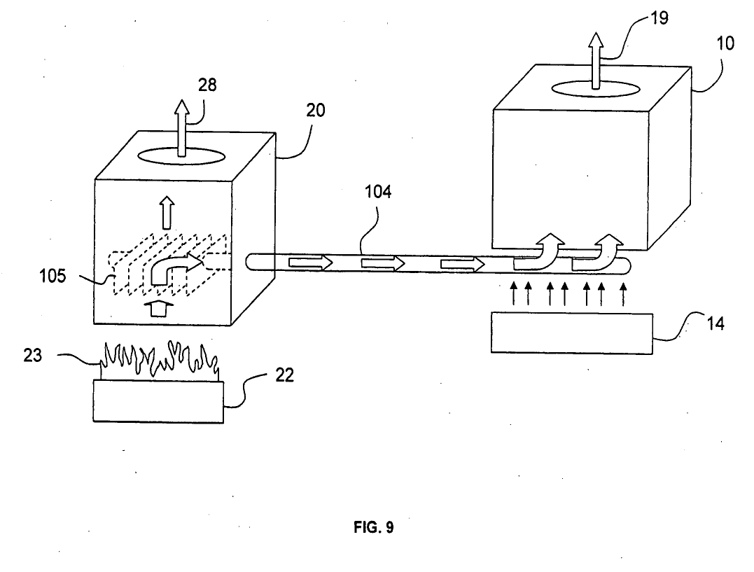

Metal fins 105 may instead be coupled to the end of the heat pipe(s) that is heated by reformer burner 20 to increase the heat transfer rate from the combustion in the burner to the fuel cell stack, as depicted in FIG. 9. The heat pipe(s) need not be placed directly in the reformer burner flame, but may be positioned appropriately in the hot combustion gases in the vicinity of the reformer burner. This flexibility allows for the placement of the heat pipe(s) at a suitable location to realize the desired temperature without overheating or underheating them.

As previously mentioned, both fuel reformer 20 and fuel cell stack 10 must be heated during start-up. This may be accomplished by providing a portion of the fuel supply to a burner. This also may be accomplished by using a combustible fuel such as commercially available propane gas or LPG, preferably when the same is packaged in a small container such as a 16-ounce disposable cylinder commonly used by campers. FIG. 1 illustrates an exemplary method for using propane as a start-up fuel. A cylinder of propane 102 is connected to the fuel cell system using commercial fittings. A valve 103 (solenoid or manual) is normally closed to isolate the propane cylinder and prevent flow of propane to the fuel reformer burner and/or fuel cell stack burner. To begin flow of propane to the burner(s), valve 103 is opened. The propane gas exiting reformer burner 22 is lit using a suitable ignition source such as a match, a lighter, an electrical spark or a hot surface igniter. An ignition port in the side of the fuel cell system case (not shown) provides direct access to the burner(s) for manual ignition using a match or lighter. The ignition port need not be more than about 2 inches in diameter or less than about 0.5 inch in diameter. To maintain the airtight qualities of the fuel cell system when it is not in operation, the opening is preferably covered with a solid plate of sufficient dimensions to completely cover it. The plate may be composed of metal or plastic. A gasket around the perimeter of the opening provides a seal between the plate and the case. The plate may be spring-loaded so as to bias the plate to snug up to the gasket, or a mechanical or magnetic fastener may serve to hold the plate closed against the gasket.

The fuel cell system preferably uses a liquid fuel that is composed of predominantly methanol and water. Typically, a 1:1 molar ratio of methanol and water (64 wt % methanol and 36 wt % water) makes up the feed stream for reforming to generate hydrogen since this composition gives the maximum yield of hydrogen per volume of fuel mix. However, it has been discovered that in order to achieve a reformate product stream from the fuel reformer with <1 vol % carbon monoxide (CO) it is preferred that the fuel mix comprise predominantly <60 wt % and most preferably <55 wt % methanol. In the specific case where the fuel mix is 55 wt % methanol and 45 wt % water, the water-gas-shift equilibrium equation, which governs the equilibrium CO content in the product reformate stream, predicts that the reformate will contain 0.7 vol % CO at 200° C. However, if the fuel mix contains 64 wt % methanol, the equilibrium CO concentration in the reformate stream will be much higher, or approximately 2.9 vol % CO. However, as the methanol concentration is reduced, the amount of hydrogen that can be produced from a given amount of fuel mix becomes less. Therefore a practical minimum concentration of methanol in the fuel mix about is 35 wt %.

The fuel mix may further contain additives in low concentration to make the fuel mix safer. Since methanol is poisonous to humans and animals if ingested, the fuel mix preferably contains Bitrex® (denatonium benzoate) at about 10 to 100 ppm, more preferably about 30 ppm, which renders the fuel mix extremely bitter-tasting. The fuel mix also preferably contains a dye that colors the fuel so that it is easily distinguishable from water. It is important that the dye be soluble in the methanol/water fuel mix and furthermore that the dye not leave significant residue upon evaporation in the fuel reformer or immediately prior to the fuel reformer where fuel vaporization occurs so as to avoid blockage of the fuel feed line to the reformer. Most water-soluble dyes are sodium salts, and these leave large quantities of undesirable residue upon evaporation. It has been discovered that fluorescein (C20H12O5, CAS No. 2321-07-5) is sufficiently soluble in the fuel mix to impart an intense yellow-green color, yet leaves little if any residue when evaporated at the fuel reformer. The concentration of fluorescein may be from 5 ppm to 1250 ppm depending on the intensity of color that is desired.

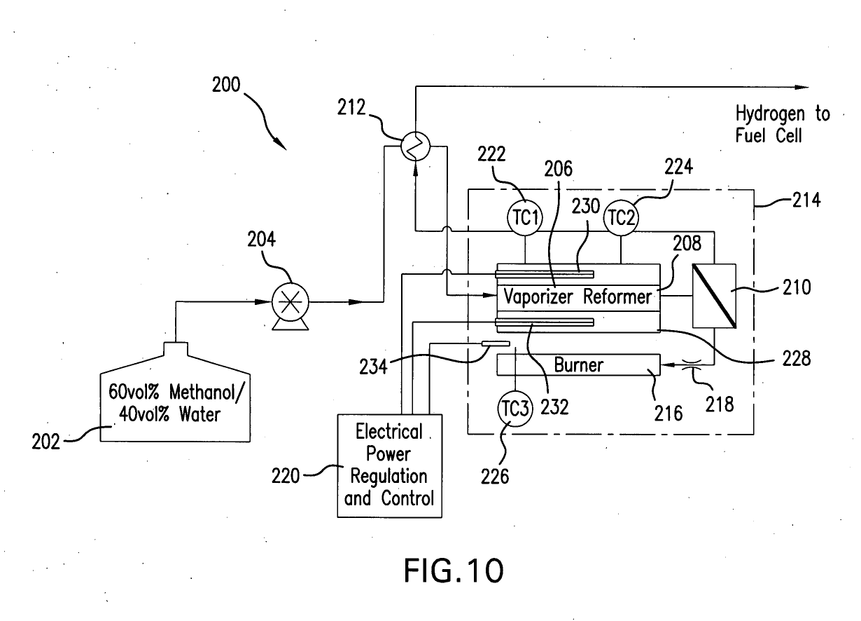

Referring now to FIG. 10, a somewhat schematic view of a fuel processor 200 is shown. For clarity, some common items such as pumps, valves, transducers and the like are omitted from FIG. 10. The fuel processor 200 converts a fuel supply 202 to provide hydrogen to a fuel cell (not shown). In one embodiment, the fuel supply 202 contains a 60/40 mix of methanol and water. The fuel may be methanol, ethanol, ethylene glycol, glycerol, propane, natural gas, diesel and the like in various mixtures. As mentioned above, it is preferable that fuel processor 200 operate over a range of temperatures, for example: inlet temperature of 150 degrees C. to 700 degrees C. and outlet temperature of 150 degrees C. to 550 degrees C.; more preferably an inlet temperature of 150 degrees C. to 550 degrees C. and outlet temperature of 250 degrees C. to 500 degrees C.; and even more preferably an inlet temperature of 150 degrees C. to 400 degrees C. and outlet temperature of 350 degrees C. to 450 degrees C. The selection of fuel has a strong influence on the operating temperature of fuel processor 200. Also, optional hydrogen purification methods downstream from fuel processor 200 may influence the preferred operating temperature (outlet temperature) of fuel processor 200. For instance, if a palladium-alloy hydrogen-purification membrane module is employed, the preferred outlet temperature of the fuel processor should be approximately the same as the operating temperature of the membrane module, about 350 degrees C. to 450 degrees C.

For the purpose of discussing FIG. 10 and without limitation, methanol/water is assumed to be the fuel; although as described above, other fuel selections may be used in conjunction with the invention. A pump 204 is connected to the fuel supply 202 for urging the fuel into a vaporizer 206 and a methanol steam reformer 208 of the fuel processor 200. The vaporizer 206 heats and vaporizes the fuel in preparation for conversion in the reformer 208. The reformer 208 chemically converts the fuel into a hydrogen-rich reformate stream that passes through a hydrogen purification membrane 210. The output of the hydrogen purification membrane 210 is purified hydrogen that is provided to the fuel cell. A heat exchanger 212 is connected to the output of the hydrogen purification membrane 210 so that the hot hydrogen output stream is cooled by the incoming liquid fuel and, in turn, the incoming liquid fuel is heated.

Several components are located in an insulated hot zone 214 in order to maintain a desired operating temperature efficiently. The hot zone 214 includes the vaporizer 206, reformer 208, the hydrogen purification membrane 210, a burner 216 and various associated components as discussed in more detail below. The hot zone 214 may be an enclosure with insulating material applied thereto.

The burner 216 provides heat to the reformer 208 so that reaction rates can occur efficiently. During normal operation, a portion of the reformate stream is diverted from the hydrogen purification membrane 210 to run the burner 216 in order to heat the reformer 208. A restricting orifice 218 is located between the hydrogen purification membrane 210 and burner 216 in order to maintain desired backpressure on the hydrogen purification membrane 210.

A control unit 220 for controlling operation of components in the hot zone 214 may be located inside or outside the hot zone 214. The control unit 220 is operatively connected to three temperature sensors 222, 224, 226. Two temperature sensors 222, 224 monitor the temperature of a heat transfer block 228 cast around the vaporizer 206 and reformer 208 while the third temperature sensor 226 monitors whether or not the burner 216 is ignited. In one embodiment, the temperature sensors 222, 224, 226 are thermocouple sensors. The control unit 220 may have an electrical power source selected from a battery, battery pack, capacitor, capacitor pack, line power and the like.

The block 228 includes one or more heaters 230, 232 that are controlled by the control unit 220. The heaters 230, 232 are used to elevate the temperature of the block 228 at start up as described in more detail below. In one embodiment, the heaters 230, 232 are cartridge type heaters approximately ⅜-inch diameter×2 inches so that the heaters 230, 232 may be inserted in an appropriately sized hole (not shown) formed in the block 228. Preferably, the block 228 has three or more heaters but two are shown for simplicity. The control unit 220 also operates an igniter 234 for the burner 216. In one embodiment, the igniter 234 is a hot silicon nitride filament but other sources to start burner ignition may be used.

Still referring to FIG. 10, from a cold start, the components in the hot zone 214 are at ambient temperature. Hence, the vaporizer 206 and reformer 208 are either not able to operate at all or not at an efficient operating temperature. The control unit 220 activates the block heaters 230, 232 to elevate the temperature of the block 228. In the case of using methanol/water fuel mix, the block heaters 230, 232 may be turned off at approximately 200-300 degrees C., as determined by the sensors 222, 224, since this is an adequate temperature for vaporizing and reforming methanol/water mixtures.

Once the block has reached an operational temperature, the pump 204 is activated to urge fuel through the vaporizer 206, reformer 208 and hydrogen purification membrane 210. As a result, the burner 216 also begins to receive a stream of reformate. The igniter 234 is used to begin burner combustion. In one embodiment, the block heaters 230, 232 remain activated until combustion is sensed at the burner 216 by the burner sensor 226. The burner 216 is configured to maintain the operating temperature in the hot zone at approximately 300-500 degrees C. and preferably between 400-450 degrees C. If the fuel processor 200 is at or near operational temperature, the use of the block heaters 230, 232 may be omitted.

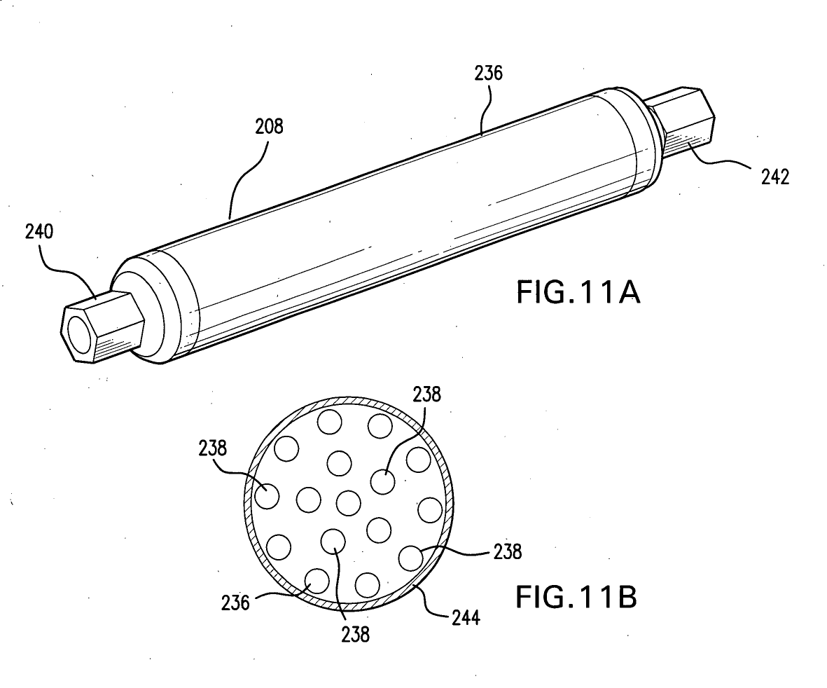

Referring now to FIGS. 11A and 11B, a tube bundle 236 for an exemplary reformer 208 is shown in perspective and cross-sectional view, respectively. The tube bundle 236 includes a plurality of tubes 238 fixed in position between an inlet header 240 and an outlet header 242. The inlet header 240 provides fluid communication between the tubes 238 and the vaporizer 206, wherein the outlet header 242 provides fluid communication between the tubes 238 and the hydrogen purification membrane 210. The tubes 238 are connected between the headers 240, 242 so that fluid flows in parallel from the inlet header 240, through the tubes 238 and exits via the outlet header 242. An optional sleeve 244 may also extend between the headers 240, 242.

Each tube 238 is relatively small in diameter so that small internal fluid reaction channels are formed therein. It is envisioned that the fluid reaction channels would be from approximately 1 to 5 mm in diameter. The inside of the tubes 238 are wash coated with a catalyst. Thus, the tubes 238 are durable because there are no catalyst materials to rub and abrade due to shock or vibration. Further, the coating on the inner diameter of the tubes 238 can withstand thermal cycling.

The diameter and length of the tubes 238 should be selected to suit the application. For example, using a BASF MeSR-1 catalyst and reforming a mixture of methanol and water at 270 degrees C. at ambient pressure to yield 10 sLm of reformate, 4 feet of ¼ inch catalyst-coated tube or 11 feet of ⅛ inch catalyst coated-tube is required. The tubes 238 could also be connected in series to achieve the desired performance. Preferably, the tubes 238 are carbon or stainless steel so that the adherent catalyst coating can be easily applied to the inner diameter.

In another embodiment, one or more tubular structures such as, without limitation, one or more U-shaped tubes are used to form the fluid reaction channels. The fluid reaction channels are preferably between 1 and 5 mm in diameter and may be fully or partially coated with catalyst. Another advantage of creating smaller fluid reaction channels is that the tubes 238 have relatively thinner walls so that the heat necessary to effectively generate reformate rapidly and more efficiently passes the relatively shorter distance to the reaction zone. In yet another embodiment, one or more annular structures such as, without limitation, one or more concentric tubes forming an annular reaction space preferably between 1 and 5 mm distance between the inner diameter and the outer diameter are used to form the fluid reaction channels.

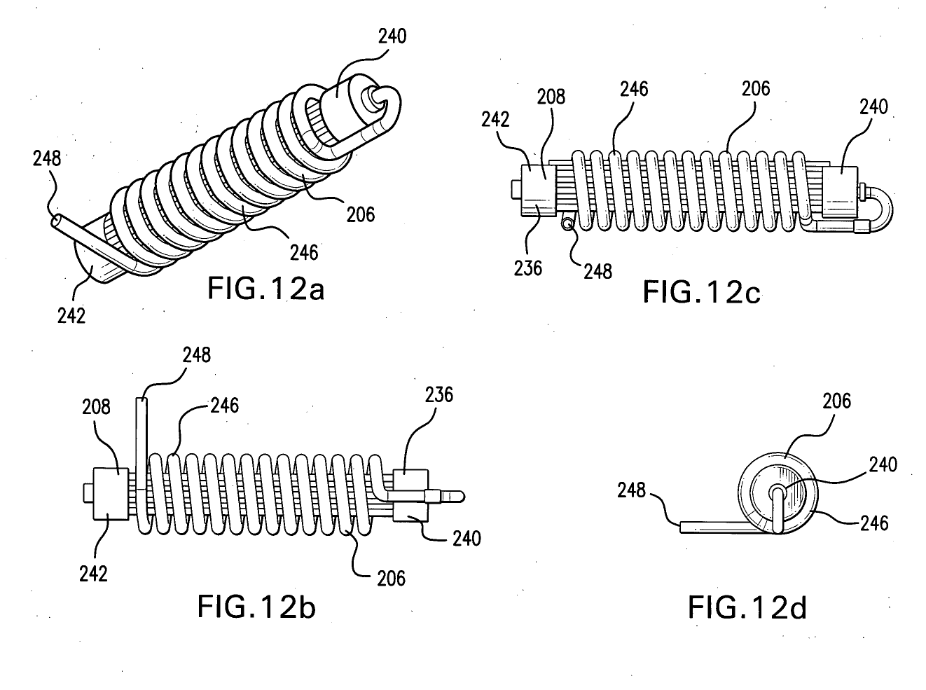

Referring now to FIGS. 12a-d, the reformer 208 is shown with the vaporizer 206 thereon. The vaporizer 206 includes a coil 246 that wraps around the tube bundle 236 and connects to the inlet header 240. Vaporizer 206 is made from one or more lengths of tubing (generally from ⅛-inch diameter to ¼-inch diameter) that is bent into a coil or other shape-suitable assembly in close proximity to the reformer 208. The vaporizer 206 has an inlet 248 that receives fuel from the fuel pump 204. By closely wrapping the vaporizer coil 246 around the tube bundle 236, the temperature of the vaporizer 206 and reformer 208 are relatively uniform when both are encased in a good heat transfer medium, and controlled by feedback from the same sensors 222, 224.

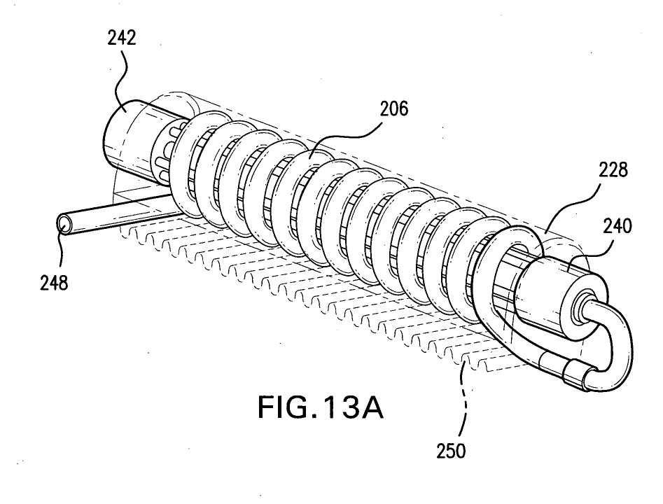

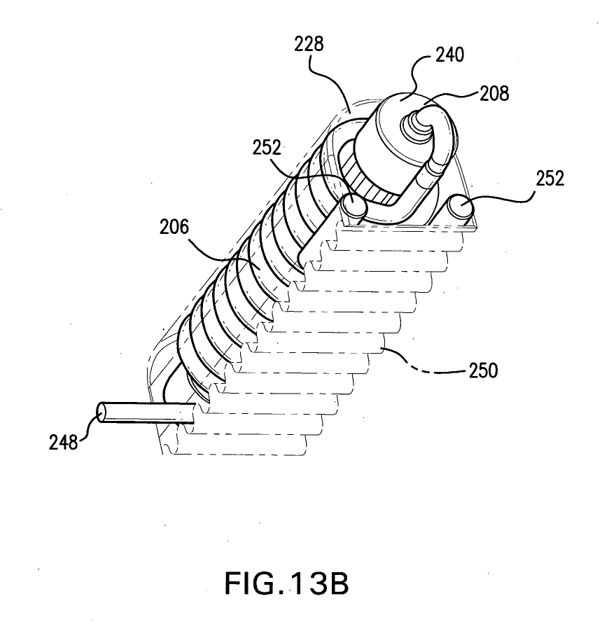

To further help distribute and control heat applied to the vaporizer coil 246 and reformer tube bundle 236, the vaporizer 206 and reformer 208 have a block 228 cast thereon as shown in FIGS. 13a and 13b. The block 228 is preferably a good conductor so that heat applied thereto is quickly and evenly distributed to both the vaporizer coil 246 and reformer tube bundle 236. Some acceptable materials for the block 228 are aluminum and aluminum alloys, copper and copper alloys, and steel. Preferably, the block 228 includes one or more cartridge heaters 252. In one embodiment, the block 228 has two heaters 252 adjacent the inlet header 240 and one heater (not shown) adjacent the outlet header 242. Alternatively, the heaters 230, 232 may be applied externally to the block 228.

The block 228 also defines optional fins 250 that increase the surface area adjacent the burner 216. Ideally, the temperature sensors 222, 224 are also inserted into the block 228. Alternatively, the temperature sensors 222, 224 may be affixed to the surface of the block 228 or to another location on the reformer 208 that is at a temperature that is representative of the reformer's. By casting the block 228 around the vaporizer 206 and reformer 208, rapid heat transfer occurs from the heaters 230, 232 and burner 216 to the vaporizer coil 246 and the reformer tube bundle 236, where the reaction zone is located. Thus, the subject hybrid technology has the advantages of using microchannel catalysts, a microchannel-like temperature gradient and the efficient manufacturability of traditional larger diameter packed bed catalysts while being compact, lightweight and durable.

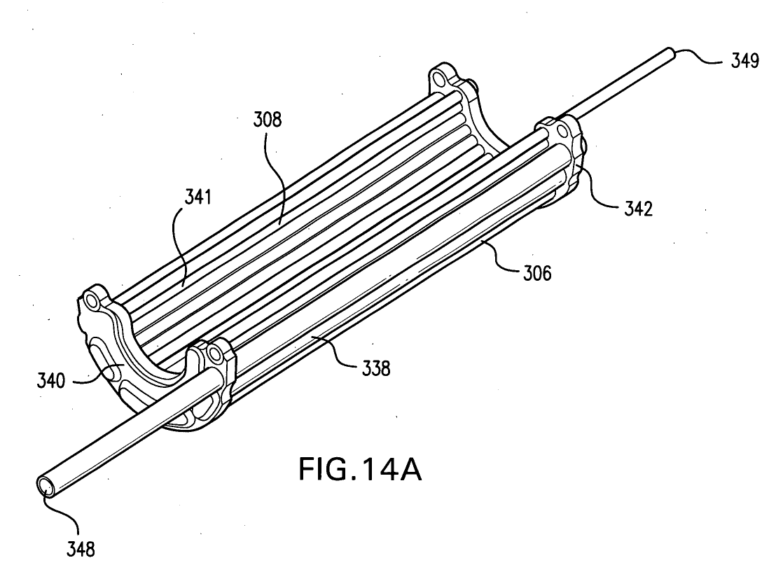

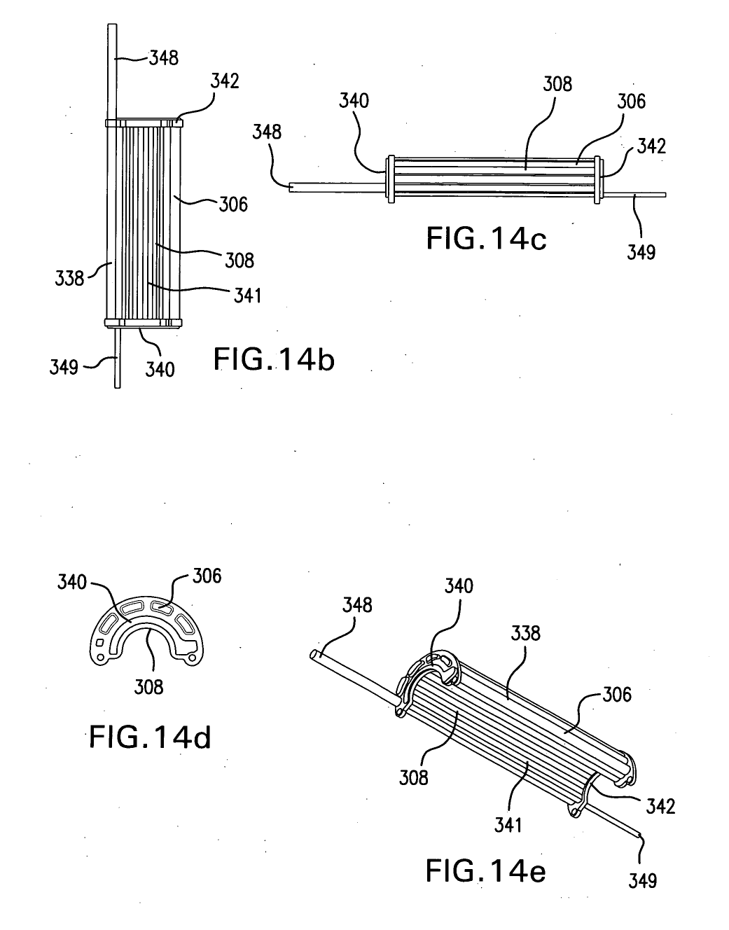

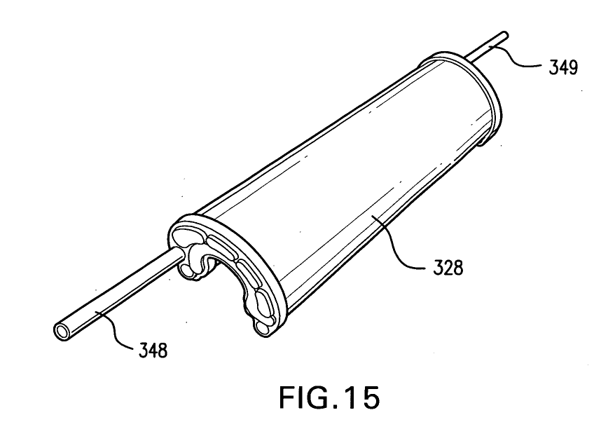

Referring to FIG. 14a-d, another vaporizer 306 and tubular reformer 308 is shown. In this embodiment, the vaporizer 306 is a plurality of tubes 338 extending between an inlet header 340 and an outlet header 342 connected to an inlet 348 and an outlet 349, respectively. The headers 340, 342 are generally arcuate shaped so that a row of vaporizer tubes 338 are parallel and adjacent a row of reformer tubes, each tube being connected in series beginning with the vaporizer tubes 338. The vaporizer tubes 338 may be ⅛-inch to ¼-inch tubes as opposed to the reforming tubes that may be ⅛ inch tubes. This vaporizer 306 and tubular reformer 308 may also be cast within a metal block 328 as shown in FIG. 15. Heating elements (not shown) may be inserted into or secured against the block 328 so that upon start up, an electrical power source may be temporarily utilized to elevate the temperature of the tubular reformer 308. Additionally, the block 328 effectively distributes the heat to the reaction zone during normal operation as well.

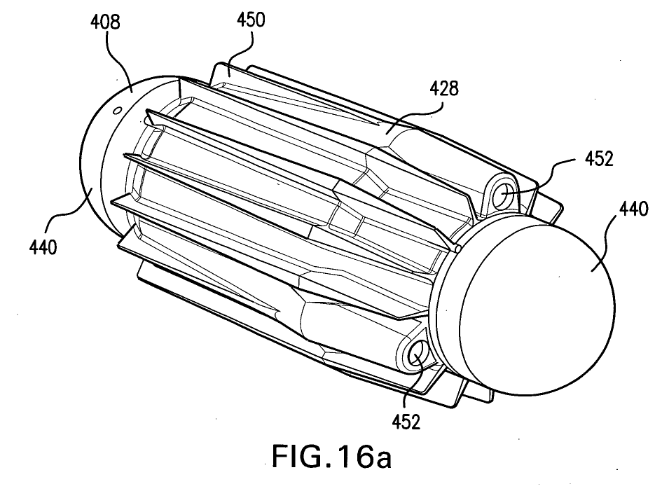

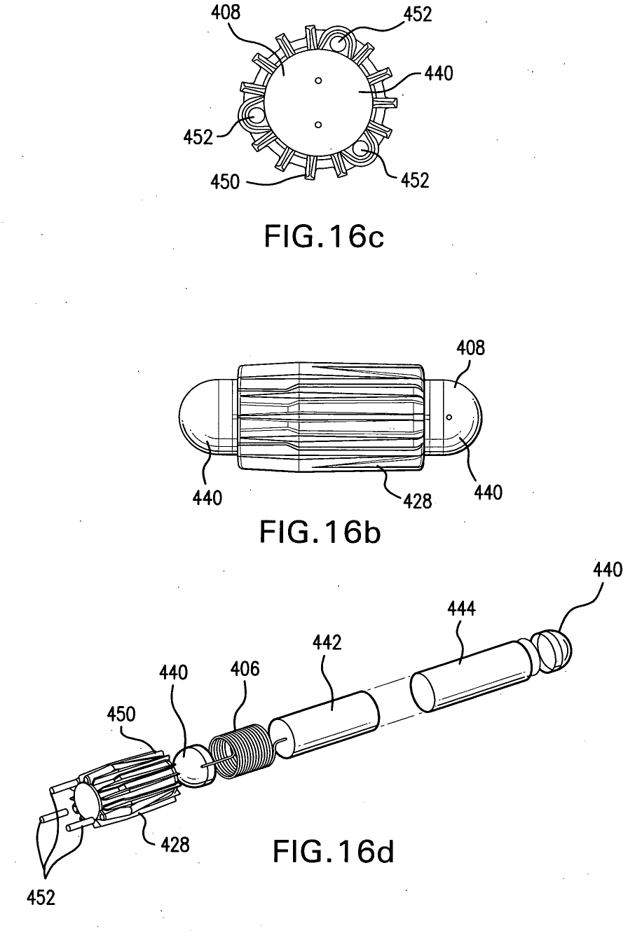

Referring now to FIGS. 16a-d, still another exemplary vaporizer 406 and tubular reformer 408 with a heat absorbing and distributing element 428 secured to the vaporizer 406 and tubular reformer 408 are shown. The tubular reformer 408 is a single annular reaction bed formed between an inner sleeve 442 and an outer sleeve 444. Preferably, the gap of the reaction bed within the tubular reformer 408 is 1.3 mm to 2.0 mm. The sleeves 442, 444 are retained between two headers 440.

The vaporizer 406 is a coil that surrounds the reformer 408 and is retained within the heat distributing element 428. The heat distributing element 428 may again be metal cast onto the vaporizer 406 and reformer 408. The heat distributing element 428 has fins 450 to provide additional surface area—to facilitate heat transfer from the burner (combustion gases) to the heat distributing element 428. One or more electrical resistance heating elements 452 are coupled to the heat distributing element 428 in order to create an operational temperature in the reaction zone prior to starting fuel flow.

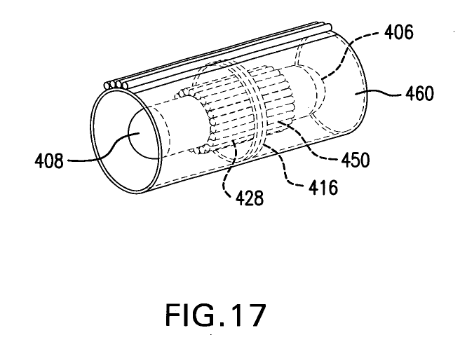

Referring now to FIG. 17, a perspective view of the vaporizer and tubular reformer 408 of FIGS. 16a-d is shown inside a housing 460. The vaporizer 406, tubular reformer 408 and element 428 are shown in phantom line within the housing 460. A burner ring 416 surrounds the element 428 to provide heat thereto during normal operation. The burner ring 416 may be centrally located (as shown) or located at either end of the assembly. The housing 460 is sized and configured to control gas flow and combine gases for more efficient reaction. The housing 460 may define a hot zone and insulation may be used to retain heat therein.

The terms and expressions which have been employed in the foregoing specification are used therein as terms of description and not of limitation. The claims may also depend from any other claim in any order and combination with all elements present or elements removed. Further, there is no intention in the use of such terms and expressions of excluding equivalents of the features shown and described or portions thereof, it being recognized that the scope of the invention is defined and limited only by the claims which follow.

1. A fuel processor assembly for producing a hydrogen rich stream for a fuel cell comprising:
a reformer;
a vaporizer adjacent the reformer;
a heat transfer block around at least a portion of the reformer and the vaporizer; and
at least one heating element coupled to the heat transfer block for providing heat to the block during start up.

2. A fuel processor as recited in claim 1, further comprising a burner adjacent the heat transfer block for providing heat to the block during normal operation.

3. A fuel processor as recited in claim 1, wherein the reformer includes a plurality of tubes held in place between an inlet header and an outlet header.

4. A fuel processor as recited in claim 3, wherein each tube is between 1 mm and 5 mm interior diameter and has an inner surface at least partially coated with catalyst.

5. A fuel processor as recited in claim 1, wherein the vaporizer is selected from the group consisting of: a coil that wraps around the reformer; vaporizer tubes held adjacent to the reformer, wherein the reformer has tubes and the vaporizer and reformer tubes are fixed between headers; at least one vaporizer tube secured within heat exchanging fins; and combinations thereof.

6. A fuel processor as recited in claim 1, wherein the heat transfer block is a metal cast onto the reformer and vaporizer, the metal being selected from the group consisting of aluminum, copper, steel, titanium and combinations and alloys thereof.

7. A fuel processor as recited in claim 1, further comprising a temperature sensor coupled to the heat transfer block.

8. A fuel processor as recited in claim 1, further comprising a hydrogen purification membrane coupled to an output of the reformer.

9. A fuel processor as recited in claim 1, wherein the reformer has tubes that are wash-coated with a catalyst.

10. A method for cold starting a fuel processor for a fuel cell comprising the steps of:
activating a block heater to elevate a temperature of a heat transfer block, wherein a vaporizer and reformer are located at least partially within the heat transfer block; and
monitoring the temperature of the heat transfer block so that the block heater is turned off near a minimum operating temperature of the reformer.

11. A method as recited in claim 10, further comprising the steps of:
activating a pump to urge fuel through the vaporizer and reformer to generate a hydrogen output stream; and
using a burner to continually heat the heat transfer block, wherein a fuel supply for the burner is a portion of the hydrogen output stream.

12. A method of building a fuel processor comprising the steps of:
providing a reformer;
coupling a vaporizer to the reformer so that an outlet of the vaporizer is in fluid communication with an inlet of the reformer;
casting a heat transfer element onto at least a portion of the vaporizer and reformer; and
applying a heating element to the heat transfer element, wherein the heating element is only utilized during cold starts.

13. A method as recited in claim 12, wherein the reformer, vaporizer and heat transfer element are located with a housing that defines a hot zone.

14. A method as recited in claim 12, further comprising the step of pumping fuel from a fuel supply into the vaporizer.

15. A method as recited in claim 12, wherein the heat transfer element is a metal block cast onto the reformer and vaporizer, the block defining at least one hole to retain the heating element.
